(19) United States
(12) Patent Application Publication
(10) Pub. No.: US 2026/0134249 A1
(43) Pub. Date: May 14, 2026

(54) DYNAMIC GENERATION OF DIGITAL TWINS

(71) Applicant: T-Mobile USA, Inc., Bellevue, WA (US)

(72) Inventors: Sandeep Dey, Bellevue, WA (US); Jan Olav Opedal, Ellensburg, WA (US); Srikrishna Srinivasan, Sammamish, WA (US); Jia Yan, Plano, TX (US)

(21) Appl. No.: 18/942,367

(22) Filed: Nov. 8, 2024

(51) Int. Cl. G06N 3/006; G06N 3/0475

(52) U.S. Cl. CPC G06N 3/006; G06N 3/0475

(57) ABSTRACT

A digital twin system receives parameters for a first chat session between a chatbot and a chatbot user of a set of chatbot users. A set of content associated with the parameters is retrieved, where the content includes data associated with past interactions between users in the set of chatbot users and one or more people having the selected parameters. Prompts are generated into a large language model (LLM) based on the parameters and the set of content. The system obtains a value of a performance metric associated with interactions between users in the set of chatbot users and one or more persons having the one or more parameters. The prompts are then modified for a second chat session based on a difference between the obtained value of the performance metric and an expected value of the performance metric.

### BACKGROUND

Individuals affiliated with an organization often need to communicate with people outside of the organization. For example, a company's sales representatives pitch to potential customers, teachers affiliated with a school instruct students, project managers in a business coordinate with external contractors, and healthcare providers in a medical office consult with patients or patients' family members. Effective communication is essential in these contexts to ensure clear, secure, and efficient interactions, ultimately enhancing the success and productivity of these engagements.

### BRIEF DESCRIPTION OF THE DRAWINGS

Detailed descriptions of implementations of the present invention will be described and explained through the use of the accompanying drawings.

FIG. 1 is a block diagram illustrating an environment in which a digital twin system operates, according to some implementations.

FIG. 2 is a flowchart illustrating a process for dynamically generating digital twins, according to some implementations.

FIGS. 3A-3B illustrate example user interfaces for selecting parameters for digital twins.

FIG. 4 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Many organizations have structured training tools or programs to help the organization's constituents improve their skills. One type of skill that is important across many different types of organizations and roles within organizations is communication skills. Traditionally, communication skills are improved by practicing interactions with other people. However, as chatbot and generative language model technologies improve, chatbots are becoming an increasingly important training tool. In an example, marketing or sales teams within an organization can use a chatbot to practice pitches to potential customers in a low-risk environment or to develop different pitch techniques that are more effective for certain types of people. Educators in a school (teachers, counselors, etc.) can use chatbots to practice conveying information to students and responding to the needs or concerns of the students. A customer service representative can use a chatbot to improve his or her ability to anticipate responses by the people the representative interacts with and to handle these responses. Likewise, a chatbot can be used by people outside an organization as they prepare for an interaction with a person inside the organization, such as preparing for an interview, a presentation, or a deposition.

However, it can be difficult for a computer system to generate a chatbot that accurately simulates different people in a way that makes the chatbot a useful training tool or practice resource. To solve these problems, the inventors have conceived of and reduced to practice techniques for dynamically generating and improving chatbots that simulate specified types of people, referred to herein as “digital twins.” According to some implementations, a computing system receives one or more parameters for a first chat session between a chatbot and a chatbot user of a set of chatbot users, where the one or more parameters specify aspects of a person to be simulated by the chatbot during the chat session. The computing system uses the one or more parameters to retrieve a set of content that includes data associated with past interactions between users in the set of chatbot users and one or more people having the one or more parameters. Based on the one or more parameters and the set of content, the computing system generates prompts into a large language model (LLM) that cause the LLM to output chat responses to corresponding chat inputs in the chat session in accordance with the one or more parameters and the set of content. The computing system then obtains a value of a performance metric associated with interactions between users in the set of chatbot users and one or more persons having the one or more parameters. The system modifies the prompts for a second chat session between the chatbot and the chatbot user of the set of chatbot users. The prompts are modified based on a difference between the obtained value of the performance metric and an expected value of the performance metric.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

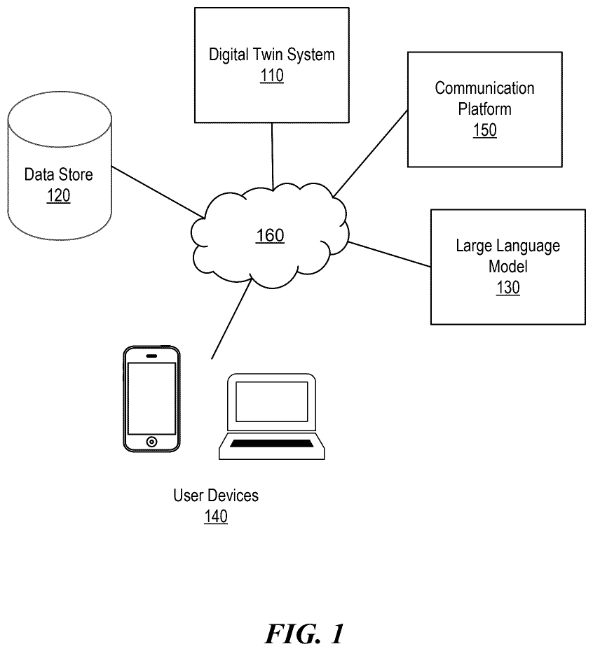

FIG. 1 is a block diagram illustrating an environment in which a digital twin system 110 operates. As shown in FIG. 1, the environment can include the digital twin system 110, one or more data stores 120, a large language model (LLM) 130, one or more user devices 140, and a communication platform 150, which can communicate over a network 160 (such as the Internet). The environment in which the digital twin system 110 operates can be an environment associated with an organization, such as an organization's enterprise network environment. In this configuration, the digital twin system 110 can be configured to access data stores 120 that are specific to the organization (e.g., cloud or on-premise data stores that are on the enterprise network or otherwise storing enterprise-specific data).

The communication platform 150 enables communication between people, such as between users affiliated with an organization and people outside the organization. The communication platform 150 can include a real-time or asynchronous messaging platform (e.g., via a chat session or via email), a platform for making telephone calls, or a video conferencing platform. As users communicate via the platform 150, the platform 150 can capture or maintain data associated with the interactions. For example, the platform 150 can capture metadata about the interactions, such as information about the people who are interacting, the communication channel used, the length of the interaction, or topic or mood analysis of the interactions. Some implementations of the communication platform 150 are further configured to capture the interactions themselves, such as by transcribing verbal interactions or storing a transcript of a chat session. The communication platform 150 can be operated by the same entity that operates the digital twin system 110 or can be operated by a third party entity. Furthermore, the communication platform 150 can include multiple communication platforms that each enable different types of interactions.

The data store 120 maintains data associated with interactions between people, such as interactions conducted through the communication platform 150. This interaction data can include metadata describing the interactions, such as when the interaction occurred, the type of interaction that occurred (e.g., real-time chat, email, or phone call), a duration of the interaction, a record of an action taken by person after the interaction, a memory of the interaction (including, for example, context for the conversation), etc. The interaction data can further include content items that are produced during or after interactions with a person. For example, the data store 120 can maintain a transcript of the interaction between a person and a representative of the organization. The data store 120 can also maintain results of surveys that are provided to people who have interacted with the organization. For example, after having an interaction with the organization, a person can complete a survey indicating whether the communication from the organization was clear, specifying whether the person understood the reason why the organization was conveying certain information to the person, providing a description of the person's response to the interaction, or forecasting whether the person will take an action based on the interaction.

Interaction data in the data store 120, including content items produced during or after interactions, can be stored in association with a set of parameters that describe the associated person who had the corresponding interaction with the organization. These parameters can include demographic information such as age, gender, ethnicity, location, occupation, education, housing features, or family attributes. Parameters can also describe a person's history with the organization. For example, if the organization is a service provider, the parameters can include information such as a length of time the person has subscribed to or used services from the organization, types of services the person has used, or whether the person has previously had any issues with the service. If the organization is a school, the parameters can include information indicating how long the person has attended the school, the person's grade level or class year, classes in which the person is currently or was previously enrolled, or the person's grades in their current or previous classes.

The digital twin system 110 simulates interactions with people to help a digital twin user improve actual interactions with these people. Digital twin users can use the digital twin to, for example, practice a sales pitch to a certain type of person, learn how to convey difficult feedback to a certain type of person, or improve interviewing or presentation skills for a certain type of person. Likewise, an organization can use interactions with the digital twin system to identify ways to better communicate certain types of information or to handle certain interactions. For example, an organization can use the digital twin interactions to develop training materials for its employees.

The digital twin system 110 generally uses the LLM 130 to produce chat outputs in response to chat inputs received from a digital twin user. Prompts into the LLM 130 are customized based on parameters that specify aspects of a person who is to be simulated during a chat session with the LLM 130, referred to herein as a “digital twin.” The digital twin system 110 provides content from the data store 120 to the LLM 130, enabling the LLM 130 to use the content to formulate chat responses that mimic the way actual people have interacted with the digital twin users or that predict the way actual people will interact with the users. The digital twins can be updated based on subsequent interactions with actual people, enabling the digital twin system 110 to continually improve the digital twins.

The user devices 140 are computing devices used by users to interact with the digital twin system 110 or with the communication platform 150.

### Dynamically Generating Digital Twins

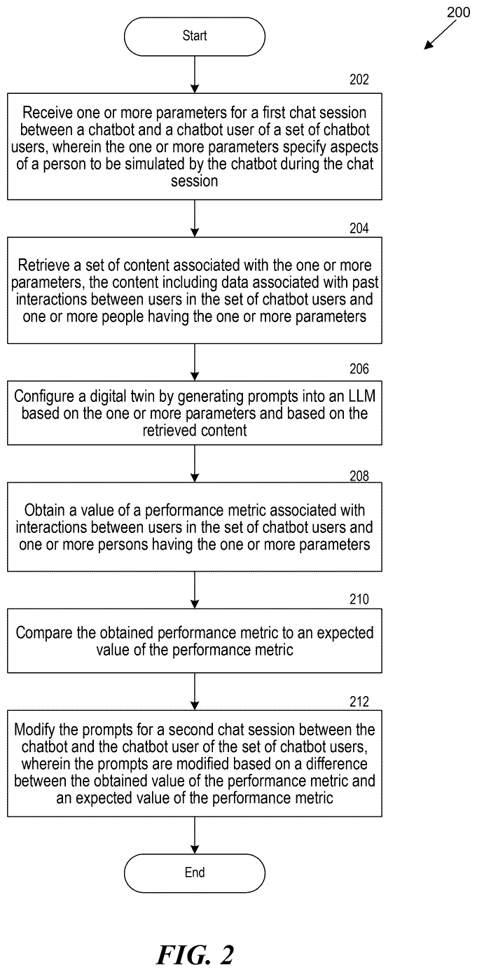

FIG. 2 is a flowchart illustrating a process 200 for dynamically generating “digital twins,” or customized chatbots that are configured to simulate a person with certain parameters. The process 200 can be performed by a computing system, such as the digital twin system 110. Other implementations of the process 200 include additional, fewer, or different steps, or perform the steps in different orders.

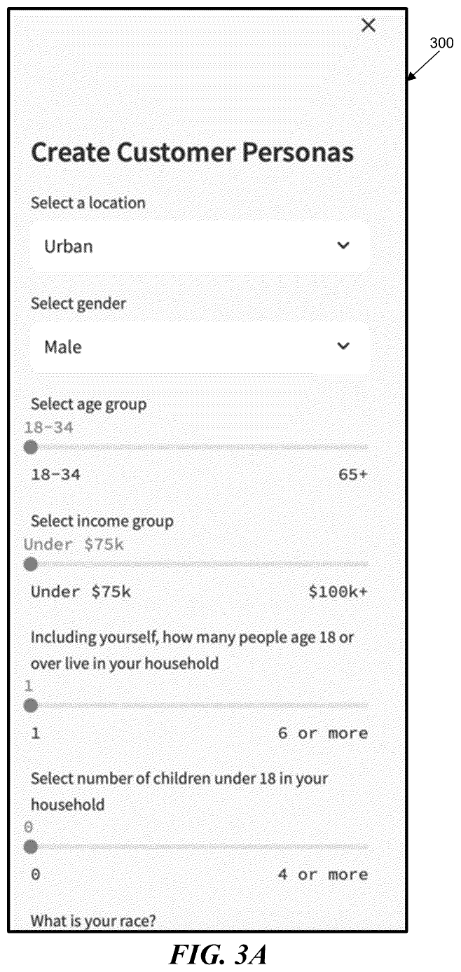

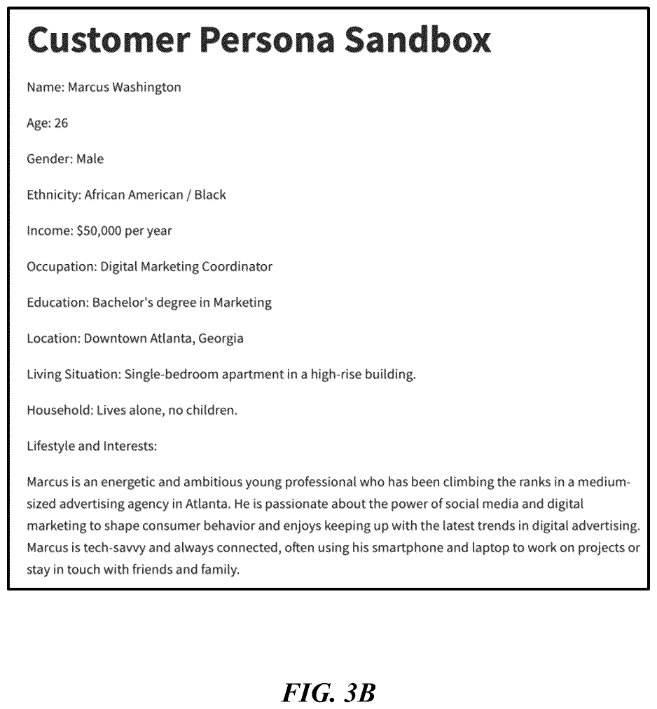

At 202, the computing system receives one or more parameters for a chat session between a chatbot, such as an LLM-enabled chatbot, and a chatbot user. The received parameters specify aspects of a person to be simulated by the chatbot during the chat session. In some implementations, the one or more parameters that are received at step 202 include at least one parameter that is selected by the chatbot user. For example, FIG. 3A illustrates an example user interface 300 by which a chatbot user specifies parameters for a simulated target person. In this example, the chatbot user can select the simulated person's location, gender, age range, income range, household size, number of children, and/or race by interacting with operable controls that specify available options for these parameters. The user interface can include options to select any of a variety of other types of parameters, and users can select any subset of the parameters that are shown. Once the user makes selections from this user interface, the computing system can display a user interface such as that shown in FIG. 3B, which describes the persona that is to be simulated by the digital twin. In some cases, the computing system can use the LLM to generate a description of the simulated persona, based on the parameters selected by the user.

Some implementations of the computing system automatically select one or more parameters for a person to be simulated in a chat session, in addition to or instead of the parameters selected by the chatbot user. For example, a user can identify particular people that the user has either interacted with in the past, or with whom the user expects to interact in the near future. The computing system can then identify one or more relevant parameters of these people and use the parameters to customize a digital twin for the user to practice interactions with simulated versions of the identified people. In another example, the computing system automatically identifies that the user has recently had interactions with certain types of people or is scheduled to interact with certain types of people in the near future, then customizes a digital twin based on parameters of these people.

At 204, the computing system retrieves a set of content associated with the selected parameters. The retrieved content includes data associated with past interactions between chatbot users and people having the selected parameters. As chatbot users interact with people via the communication platform 150, data associated with these interactions is captured and stored (e.g., in the data store 120). The data that is retrieved at step 204 can include records of the past interactions themselves, such as transcripts of chat sessions or telephone or video calls between a user and another person. In some cases, the computing system can perform an analysis of the interactions either in real-time during the interaction or by processing a transcript or recording of the interaction, for example to detect tone or mood of the people who are interacting. The retrieved data can also include data that is collected after the interaction, but indicative of how a person responded to the interaction. For example, the organization that operates the digital twin system 110 can send surveys to some of the people who interact with the organization, soliciting information about the interaction such as the clarity of the message conveyed in the interaction or the likelihood that the person will take certain actions after the interaction. The organization can also store data about actions taken by people after their interactions with the organization, such as recording whether a customer purchased a product, started or stopped service, or modified their subscription to a service after an interaction.

At 206, the computing system configures the digital twin by generating prompts into an LLM based on the one or more parameters and based on the retrieved content. The prompts cause the LLM to output chat responses to corresponding chat inputs received from the chatbot user. For example, an initial prompt (or a prompt in an initial set of prompts) can provide the LLM with the retrieved content, instructing the LLM to use the retrieved content to simulate a person who has the one or more parameters. Then, as the chatbot user provides chat inputs, these chat inputs can be sent to the LLM with additional prompts that instruct the LLM to generate chat outputs in response to the inputs. In some cases, the prompts can specify a desired outcome or performance metric. For example, the LLM can be instructed to simulate interactions of a customer who is likely to cancel a service, training the chatbot user to interact with this customer in a way that reduces the customer's proclivity to cancellation. In another example, the LLM can be instructed to simulate a person who becomes angrier over the course of an interaction, training the chatbot user to deescalate the conversation.

The chatbot user can interact with the chatbot, simulating a conversation with a person who has the parameters specified for the digital twin. After practicing these interactions, the user can then conduct real interactions with people who may or may not share these parameters. Likewise, other users (who are, for example, affiliated with the same organization as the chatbot user) can interact with people who share the parameters that were used to customize the digital twin.

As users of the computing system interact with real people, the computing system can generate performance metrics for these interactions. Performance metrics can provide any relevant measurements for how well a user performed during an interaction or the outcomes of the interactions. If an organization is a service provider, the performance metrics related to interactions between employees of the organization (e.g., sales people or support technicians) and customers or potential customers of the organization can include, for example, a measurement of how many customers started using the service, how many customers stopped using the service, customer responses to surveys after an interaction with the organization, or whether further interactions were held with the customer after a given interaction. If an organization is a school, the performance metrics related to interactions between teachers in the school and students can include, for example, a measurement of the number of students who passed a class, a number of students who achieved a certain score on a test, an average score across a class of students, or a number of students who enrolled in a subsequent class.

At 208, the computing system obtains a value of a performance metric associated with interactions with people who have the parameters that were used to customize the digital twin. For example, the computing system filters the interactions to find any interaction that occurred during a certain time window with a person who had at least one of the parameters used to customize the digital twin. From these filtered interactions, the computing system then determines the value of the performance metric associated with the interactions. In one example, the computing system identifies any interactions with subscribers to a company's service in the age range of 18-30, and determines a performance metric that indicates the number of these subscribers who canceled their service after an interaction with a user in the company. The interactions from which the performance metric is obtained can be interactions with any user in an organization who has communicated with a person who has one of the applicable parameters, in some cases, or can be filtered to certain subsets of users in an organization (e.g., any user who has used a digital twin to practice interactions with people who have the applicable parameters).

The computing system then compares, at 210, the obtained performance metric to an expected value of the performance metric. For example, the computing system may expect that a certain number of service subscribers between 18-30 years old will cancel their service after an interaction with an employee of the service provider, based on historical data that indicates how often this churn occurs. The actual number of subscribers who cancel service after a chatbot user uses the digital twin is then compared to this expected number. By comparing the obtained performance metric to the expected performance metric, the computing system can determine whether the digital twin is accurately simulating the behavior of certain people or whether the digital twin is helping users improve their interactions with people.

Based on a difference between the obtained value of the performance metric and the expected value of the performance metric, the computing system at 212 modifies prompts into the LLM for the digital twin. Modifying the prompts can include changing the set of content that is provided to the LLM as the basis for simulating a user or modifying instructions in the prompts. The prompts can be modified for any future chat session that uses the same parameters to customize the digital twin. In one example, the difference between the obtained value and expected value of the performance metric indicates that the digital twin is not accurately simulating interactions with a certain type of person, resulting in the obtained performance metric being greater or smaller than the expected value by at least a threshold amount. The computing system therefore can modify the prompts into the LLM for the next chat session that uses the parameters of this type of person to, for example, remove content that is not applicable to simulating the type of person, add content that helps the LLM better simulate the type of person, or instruct the LLM to use the content in different ways while simulating the person who has the set of specified parameters. The prompts can be supplemented or modified based on the actual interactions with the people who have the specified parameters after the first chat session. In another example, the difference between the obtained value and expected value of the performance metric indicates that the digital twin is not sufficiently helpful for a user to improve his or her interactions with a certain type of person (e.g., because the obtained value of the performance metric is not significantly better than the expected value). Accordingly, the prompts that are used to simulate this type of person can be modified for the next chat session with the digital twin, resulting in a chatbot that better trains a user to interact with this type of person.

### Large Language Models

A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

Many machine learning techniques are based on neural networks. A neural network model has three major components: architecture, cost function, and search algorithm. The architecture defines the functional form relating the inputs to the outputs (in terms of network topology, unit connectivity, and activation functions). During a training process, a computing system performs a search in weight space for a set of weights that minimizes the objective function.

A neural network has a set of input nodes that receive input data. The input nodes can correspond to functions that receive the input and produce results. These results can be provided to one or more levels of intermediate nodes (“hidden layers”) that each produce further results based on a combination of input node results. A weighting factor is applied to the output of each input node before the result is passed to the hidden layer nodes. The hidden layer can have lower dimensionality than the input and/or output layers, in some implementations. At a final layer (“the output layer”), a set of output nodes are mapped to output data. Once the neural network is trained, application of the field values to the input and output nodes produces a latent vector at the hidden layer that represents features of the input data.

Some neural networks, known as deep neural networks, have multiple layers of intermediate nodes with different configurations, are a combination of models that receive different parts of the input and/or input from other parts of the deep neural network, or are convolutions-partially using output from previous iterations of applying the model as further input to produce results for the current input.

A large language model uses a neural network, usually a deep neural network, to perform natural language processing (NLP) tasks. A language model may contain hundreds of thousands of learned parameters, and large language models in particular may contain millions or billions of learned parameters.

Some LLMs are implemented using transformers, which are a type of neural network architecture that uses self-attention mechanisms in order to generate predicted output based on input data that has some sequential meaning. Although example functions of a transformer are described herein, a person of skill in the art will recognize that other language models can be used, including language models based on other neural network architectures such as recurrent neural network (RNN)-based language models.

A transformer includes an encoder (which may comprise one or more encoder layers/blocks connected in series) and a decoder (which may comprise one or more decoder layers/blocks connected in series). The encoder and decoder can each include a plurality of neural network layers, at least one of which may be a self-attention layer. The parameters of the encoder and decoder's neural network layers may be referred to as the parameters of the language model.

The transformer is trained on a text corpus, which can be labeled (e.g., annotated to indicate verbs, nouns, etc.) or unlabeled.

To process textual input data using the transformer, a natural language string is tokenized into integers that correspond to the index of a text segment (e.g., a word, a punctuation mark, formatting information, classification information, etc.) in a vocabulary dataset. A length of the natural language string that can be processed by the transformer may be limited by the dimensions of the transformer.

An embedding is then generated for each of the tokens from the string. An embedding, also referred to as an embedding vector, is a numerical representation of a token that captures some semantic meaning of the text segment represented by the token. An embedding represents the text segment corresponding to the token in a way such that embeddings corresponding to semantically-related text are closer to each other in a vector space than embeddings corresponding to semantically-unrelated text. To generate the embedding, a system can apply the token to a trained neural network that generates an embedding based on a vector in a latent space of the neural network. In other implementations, the numerical value of the token can be used to look up the corresponding embedding in an embedding matrix, which may be learned during training of the transformer.

The embeddings are input at the first layer of the encoder. The encoder encodes the embeddings into feature vectors that represent the latent features of the embeddings. The encoder can encode positional information of the tokens (i.e., information about the sequence of the input) in the feature vectors. The feature vectors may have very high dimensionality (e.g., on the order of thousands or tens of thousands), with each element in a feature vector corresponding to a respective feature. Each element in the feature vector has a numerical weight that represents the importance of the corresponding feature. The space of all possible feature vectors that can be generated by the encoder may be referred to as the latent space or feature space.

The decoder maps the features represented by the feature vectors into meaningful output, which may depend on the task that was assigned to the transformer. For example, if the transformer is used for a translation task, the decoder maps the feature vectors into text output in a target language different from the language of the original tokens. Generally, in a generative language model, the decoder serves to decode the feature vectors into a sequence of tokens. The decoder may generate output tokens one by one. Each output token can be fed back as input to the decoder in order to generate the next output token. By feeding back the generated output and applying self-attention, the decoder generates a sequence of output tokens that has sequential meaning (e.g., the resulting output text sequence is understandable as a sentence and obeys grammatical rules). The resulting sequence of output tokens is then converted to a text sequence in post-processing. For example, like the input tokens, each output token is an integer number that corresponds to a vocabulary index. By looking up the text segment using the vocabulary index, the text segment corresponding to each output token can be retrieved. The resulting text segments can be concatenated and the final output text sequence can be obtained.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

### Computer System

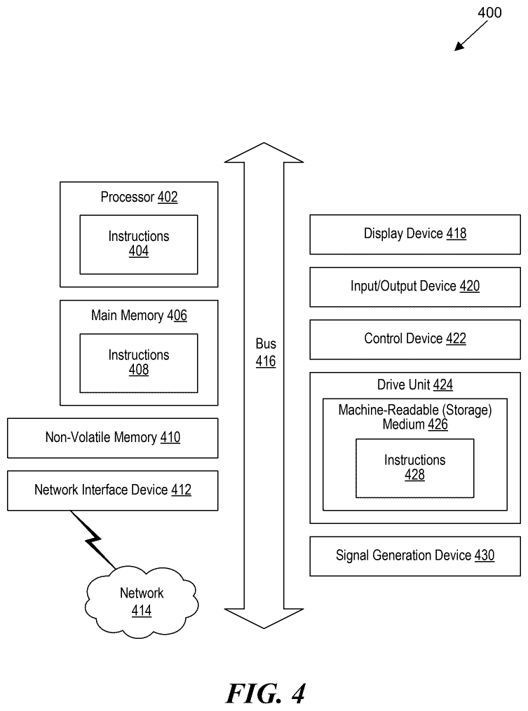

FIG. 4 is a block diagram that illustrates an example of a computer system 400 in which at least some operations described herein can be implemented. As shown, the computer system 400 can include: one or more processors 402, main memory 406, non-volatile memory 410, a network interface device 412, a video display device 418, an input/output device 420, a control device 422 (e.g., keyboard and pointing device), a drive unit 424 that includes a machine-readable (storage) medium 426, and a signal generation device 430 that are communicatively connected to a bus 416. The bus 416 represents one or more physical buses and/or point-to-point connections that are connected by appropriate bridges, adapters, or controllers. Various common components (e.g., cache memory) are omitted from FIG. 4 for brevity. Instead, the computer system 400 is intended to illustrate a hardware device on which components illustrated or described relative to the examples of the figures and any other components described in this specification can be implemented.

The computer system 400 can take any suitable physical form. For example, the computing system 400 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 400. In some implementations, the computer system 400 can be an embedded computer system, a system-on-chip (SOC), a single-board computer system (SBC), or a distributed system such as a mesh of computer systems, or it can include one or more cloud components in one or more networks. Where appropriate, one or more computer systems 400 can perform operations in real time, in near real time, or in batch mode.

The network interface device 412 enables the computing system 400 to mediate data in a network 414 with an entity that is external to the computing system 400 through any communication protocol supported by the computing system 400 and the external entity. Examples of the network interface device 412 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 406, non-volatile memory 410, machine-readable medium 426) can be local, remote, or distributed. Although shown as a single medium, the machine-readable medium 426 can include multiple media (e.g., a centralized/distributed database and/or associated caches and servers) that store one or more sets of instructions 428. The machine-readable medium 426 can include any medium that is capable of storing, encoding, or carrying a set of instructions for execution by the computing system 400. The machine-readable medium 426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 404, 408, 428) set at various times in various memory and storage devices in computing device(s). When read and executed by the processor 402, the instruction(s) cause the computing system 400 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A non-transitory, computer-readable storage medium comprising instructions recorded thereon, wherein the instructions when executed by at least one data processor of a system, cause the system to:
receive one or more parameters for a first chat session between a chatbot and a chatbot user of a set of chatbot users, wherein the one or more parameters specify aspects of a person to be simulated by the chatbot during the chat session;
retrieve a set of content associated with the one or more parameters, the content including data associated with past interactions between users in the set of chatbot users and one or more people having the one or more parameters;
generate prompts into a large language model (LLM) based on the one or more parameters and the set of content,
wherein the prompts cause the LLM to output chat responses to corresponding chat inputs in the chat session in accordance with the one or more parameters and the set of content;
obtain a value of a performance metric associated with interactions between users in the set of chatbot users and one or more persons having the one or more parameters; and
modify the prompts for a second chat session between the chatbot and the chatbot user of the set of chatbot users, wherein the prompts are modified based on a difference between the obtained value of the performance metric and an expected value of the performance metric.

2. The non-transitory computer-readable storage medium of claim 1, wherein receiving the one or more parameters for the first chat session comprises:
sending for display to a user, a user interface that includes operable controls for selecting the one or more parameters.

3. The non-transitory computer-readable storage medium of claim 1, wherein the instructions when executed further cause the system to select the one or more parameters.

4. The non-transitory computer-readable storage medium of claim 1, wherein the data associated with the past interactions between the users in the set of chatbot users and one or more people having the one or more parameters includes:
transcripts of conversations between the users in the set of chatbot users and one or more people having the one or more parameters; or
survey results indicating reactions by the one or more people having the one or more parameters to conversations with users in the set of chatbot users.

5. The non-transitory computer-readable storage medium of claim 1, wherein modifying the prompts comprises modifying the set of content.

6. The non-transitory computer-readable storage medium of claim 1, wherein modifying the prompts comprises changing an instruction for how to use the set of content in the prompt.

7. The non-transitory computer-readable storage medium of claim 1, wherein the prompts are modified based on the difference between the obtained value of the performance metric and the expected value of the performance metric being less than a threshold.

8. The non-transitory computer-readable storage medium of claim 1, wherein the prompts are modified based on the difference between the obtained value of the performance metric and the expected value of the performance metric being greater than a threshold.

9. A system comprising:
at least one hardware processor; and
at least one non-transitory memory storing instructions, which, when executed by the
at least one hardware processor, cause the system to:
receive one or more parameters for a first chat session between a chatbot and a chatbot user of a set of chatbot users, wherein the one or more parameters specify aspects of a person to be simulated by the chatbot during the chat session;
retrieve a set of content associated with the one or more parameters, the content including data associated with past interactions between users in the set of chatbot users and one or more people having the one or more parameters;
generate prompts into a large language model (LLM) based on the one or more parameters and the set of content,
wherein the prompts cause the LLM to output chat responses to corresponding chat inputs in the chat session in accordance with the one or more parameters and the set of content;
obtain a value of a performance metric associated with interactions between users in the set of chatbot users and one or more persons having the one or more parameters; and
modify the prompts for a second chat session between the chatbot and the chatbot user of the set of chatbot users, wherein the prompts are modified based on a difference between the obtained value of the performance metric and an expected value of the performance metric.

10. The system of claim 9, wherein receiving the one or more parameters for the first chat session comprises:
sending for display to a user, a user interface that includes operable controls for selecting the one or more parameters.

11. The system of claim 9, wherein the instructions when executed further cause the system to select the one or more parameters.

12. The system of claim 9, wherein the data associated with the past interactions between the users in the set of chatbot users and one or more people having the one or more parameters includes:
transcripts of conversations between the users in the set of chatbot users and one or more people having the one or more parameters; or
survey results indicating reactions by the one or more people having the one or more parameters to conversations with users in the set of chatbot users.

13. The system of claim 9, wherein modifying the prompts comprises modifying the set of content.

14. The system of claim 9, wherein modifying the prompts comprises changing an instruction for how to use the set of content in the prompt.

15. The system of claim 9, wherein the prompts are modified based on the difference between the obtained value of the performance metric and the expected value of the performance metric being less than a threshold.

16. The system of claim 9, wherein the prompts are modified based on the difference between the obtained value of the performance metric and the expected value of the performance metric being greater than a threshold.

17. A method comprising:
receiving, at a computer system, one or more parameters for a first chat session between a chatbot and a chatbot user of a set of chatbot users, wherein the one or more parameters specify aspects of a person to be simulated by the chatbot during the chat session;
retrieving a set of content associated with the one or more parameters, the content including data associated with past interactions between users in the set of chatbot users and one or more people having the one or more parameters;
generating, by the computer system, prompts into a large language model (LLM) based on the one or more parameters and the set of content,
wherein the prompts cause the LLM to output chat responses to corresponding chat inputs in the chat session in accordance with the one or more parameters and the set of content;
obtaining a value of a performance metric associated with interactions between users in the set of chatbot users and one or more persons having the one or more parameters; and
modifying, by the computer system, the prompts for a second chat session between the chatbot and the chatbot user of the set of chatbot users, wherein the prompts are modified based on a difference between the obtained value of the performance metric and an expected value of the performance metric.

18. The method of claim 17, wherein receiving the one or more parameters for the first chat session comprises:
sending for display to a user, a user interface that includes operable controls for selecting the one or more parameters.

19. The method of claim 17, wherein the instructions when executed further cause the system to select the one or more parameters.

20. The method of claim 17, wherein the data associated with the past interactions between the users in the set of chatbot users and one or more people having the one or more parameters includes:
transcripts of conversations between the users in the set of chatbot users and one or more people having the one or more parameters; or
survey results indicating reactions by the one or more people having the one or more parameters to conversations with users in the set of chatbot users.
